(19) United States
(12) Patent Application Publication
(10) Pub. No.: US 2008/0133471 A1
(43) Pub. Date: Jun. 5, 2008

(54) Communication System

(75) Inventors: John Burgess, London (GB); Olivier Decrock, Saint Ouen (FR); Khashayar Mahdavi, Geneva (CH); Alan Price, London (GB)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Telnic Limited, London (GB)

(21) Appl. No.: 10/551,801

(22) PCT Filed: Apr. 1, 2004
(86) PCT No.: PCT/EP04/03465

§ 371 Date: Feb. 7, 2007

(30) Foreign Application Priority Data
Apr. 1, 2003 (GB) 0307384.8

(51) Int. Cl. G06F 17/30

(52) U.S. Cl. 707/3; 707/E17.108

(57) ABSTRACT

A communications system in a user queries a first database regarding a registered user identifier and uses the response of the first database to query a second database to access a data set regarding the registered user. The system may also comprise a third server comprising hierarchical data that defines a relationship between a plurality of data sets regarding the registered user, enabling the user to access a selected data set.

The present invention relates to a communication system, and in particular to a communication system which simplifies the association of an entity (such as a person or organisation) with one or more data sets associated with the that entity.

One of the most important and significant components of the internet infrastructure are domain name servers (DNS). These provide a translation between the numerical internet protocol addresses (for example 192.168.1.1) with the alphabetical addresses that are easier for users to remember and distinguish between (for example yahoo.com). A DNS enables a suitable client to access all the data published within it such that a request comprising an alphabetical address is directed to the correct IP address.

According to a first aspect of the invention, there is provided a communications system comprising a first database and a second database, the first database comprising data identifying a system user and the second database comprising one or more data sets relating to a system user, the system being characterised in that: i) the first database additionally comprises data indicating the location of the one or more data sets relating to that user; ii) the second database comprises a plurality of data sets relating to a system user and iii) the system further comprises a third database, the third database comprising hierarchical data defining a relationship between the plurality of data sets.

The first database, on receiving a first request from a client terminal, may send a first response to the client terminal, the first request comprising identification data for a system user and the first response comprising data indicating the location of one or more data sets relating to that user. Furthermore, the second database, on receiving a second request from a client terminal, may send a second response to the client terminal, the second request comprising an identification of a requested data set and the second response comprising the requested data set.

The hybrid system in which the registry stores only data associating names, whilst the data items associated with these names are stored externally to the registry in a separate data store, which may be a distributed hierarchical data store such as a DNS. The registry can be informed of sub-domains, allowing the data to be published selectively based on the class of user requesting information and on the access control policies specified for each domain. The configuration of this hybrid system allows the domains and their contained items to be held on a distributed data store that provides one set of data, whilst storing supplementary sets of relational information within a registry that can select which set to return based on the querying user's identity as well as the domain in which they are interested.

This has the benefit of maintaining control for publication of the contained items within the distributed data store; the registry does not store these items but only references to the domain name identifiers. It also ensures that there is only one copy of the data items, whilst allowing different “views” on the relationships between the domains that contain the items based on a querying user's identity.

Having only one copy of the data items removes a problem of synchronization between different systems holding copies. However, information on the hierarchy that relates different domains (that is not normally available to the public through the DNS system) is stored separately in the registry where it can be provided with controlled access, with different information being provided depending on the identity of the user asking for it.

According to a second aspect of the invention, there is provided a mobile communications device comprising processor means, data storage means, memory means and display means, the device, in use being configured to: i) send a first request comprising a user identifier to a first system database; ii) receive a first response from the first system database comprising a location for a second system database; iii) send a second request to the location of the second system database; iv) receive a second response from the second system database comprising a data set related to the user identifier comprised in the first request; characterised in that the device is configured to v) send a third request to a third system database; and vi) receive a third response from the a third system database comprising hierarchical data defining relationships for the data set received in step iv) between the of second data records.

According to a third aspect of the invention, there is provided a communications system comprising a first database and a second database, wherein: the first database comprises a plurality of first data records, each of the first data records being associated with a registered user of the communications system and comprising a registered user identifier and a data resource locator; and the second database comprises a plurality of second data records, each of the second data records being associated with a registered user of the communications system and comprising one or more data sets associated with that registered user, the system being configure such that when a first data record is added to the first database, the system adds a second data record to the second database, the contents of the second data record being derived from the data submitted to the first database; the system being characterised in that the system further comprises a third database, the third database comprising a plurality of third data records, each third data record being associated with a registered user further associated with a first data record and a plurality of second data records, wherein each third data record comprises hierarchical data defining a relationship between the plurality of second data records.

Such a system enables the registry to ensure that data is based on the domains that exist in an external database and to limit the ability of external users to create relations based on those domains so that only the person responsible for the creation of that domain is allowed to create relations based on it. The relationship between a registry and an NSP (name service provider) using this automatic notification improves the efficiency of the registrar considerably, whilst minimising the privileged data that flows through the notifications. When a new domain has been created the information on that domain and on the person responsible for its creation is only known to the registrar. The NSP gets this information through an automatic notification process.

The relationship between a registrar and an NSP using this automatic notification process simplifies the registry's subsequent task of capturing data on relations between these names, and additionally other names that are added as part of this process, as they are received as automatic notifications from a trusted source. This supplementary relational data can be used by querying users to relate names to one another. As there can be more than one set of relational data for a given domain, the data returned can be based on the identity of the querying user.

A similar approach can be used to populate a search-engine with names of the persons responsible for having a domain created. This allows a querying user to search based on the name of that responsible person, and for the search engine to return the domains with which they are associated, or to use affinity-based searches to return the domains associated with people whose names are the “nearest matches” for the name passed by the user as a search term. Thus, the efficiency of the search engine sub-system is improved, as otherwise it would be necessary to poll the registrar to find out if new domains had been created.

The invention will now be described, by way of example only, with reference to the following Figures in which:

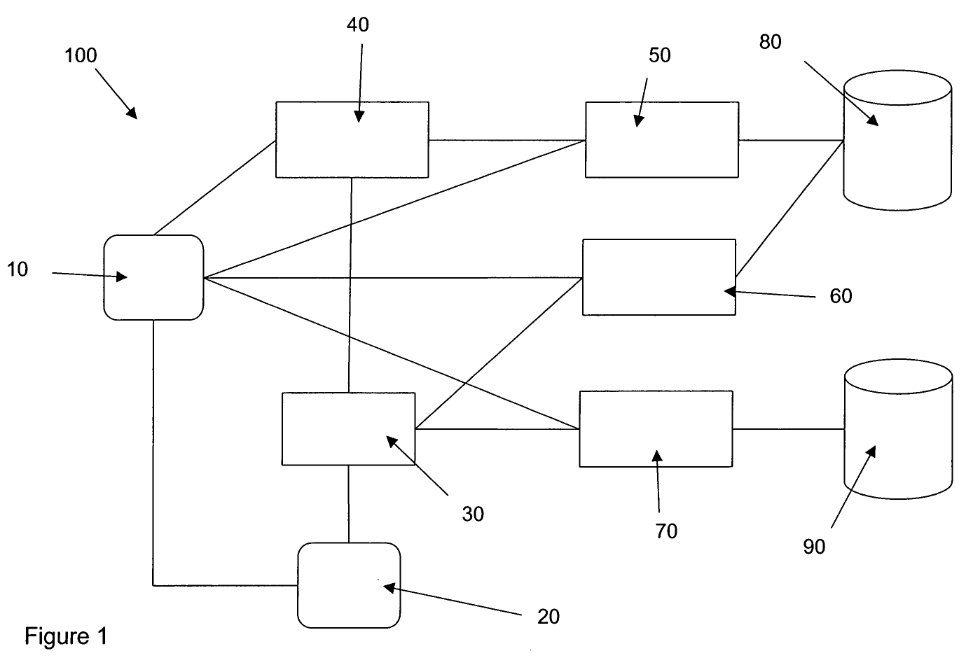

FIG. 1 shows a schematic depiction of a system according to the present invention;

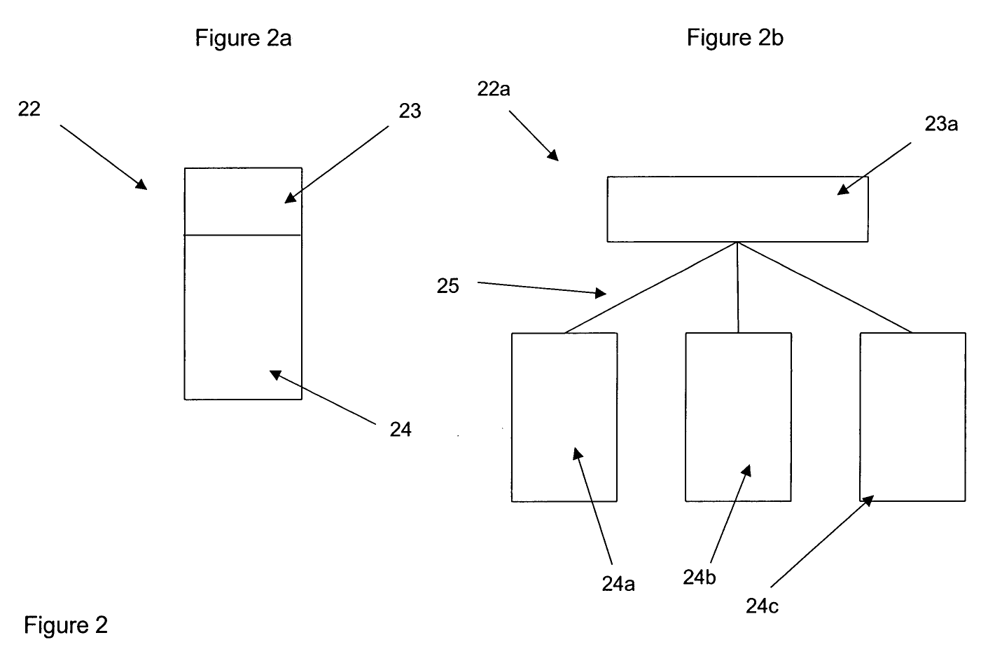

FIG. 2 shows schematic depictions of data records associated with a registered user of a system according to the present invention;

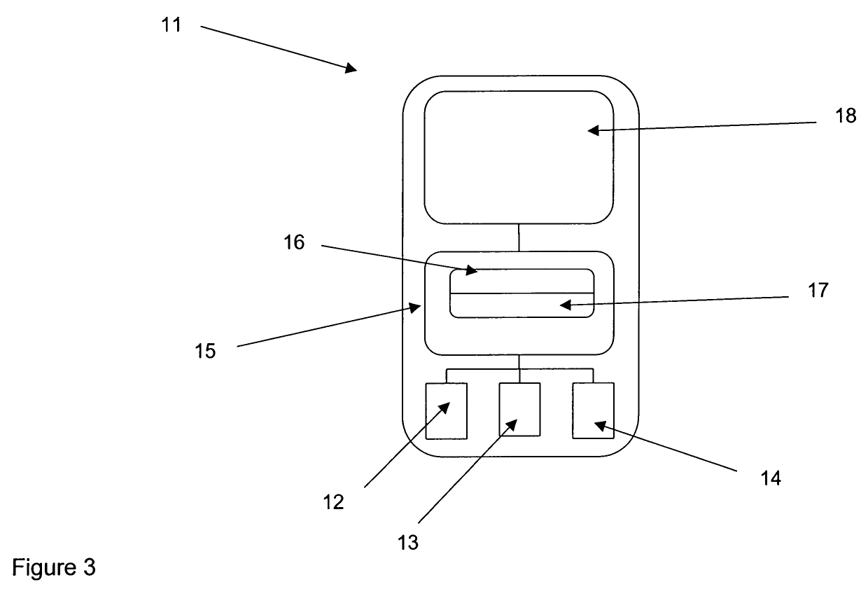

FIG. 3 shows a schematic depiction of a mobile communications device according to the present invention; and

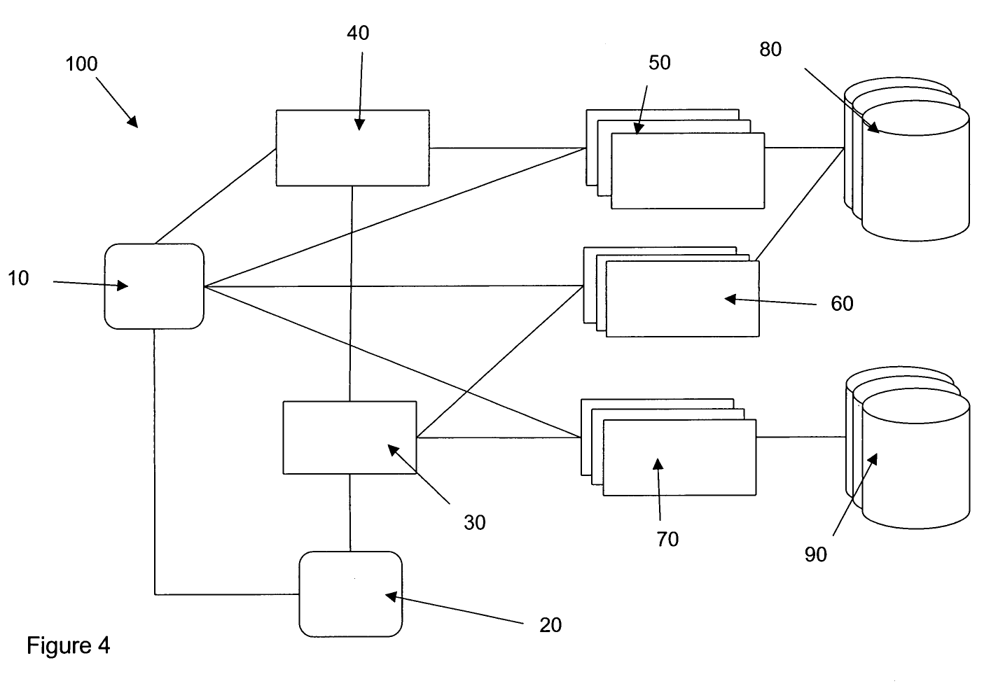

FIG. 4 shows a further embodiment of a system according to the present invention.

FIG. 1 shows a schematic depiction of a system 100 according to the present invention. The system 100 comprises a user 10, a registered user 20, a registrar 30, a registry 40, a search engine 50, a name service provider (NSP) 60, a name navigation service provider (NNSP) 70, an NSP database 80 and an NNSP database 90. It will be readily appreciated that the system will operate with a plurality of both users 10 and registered users 20 but for the sake of simplicity the following discussion will be limited to a single user and registered user.

The system enables a user 10, which comprises a mobile communications device (such as a mobile telephone, or wireless-enabled PDA or similar device) to obtain details regarding a registered user that has been registered with the system. Such details may comprise contact data (telephone number(s), fax number, email and/or instant messaging address, etc.) data related to content (internet address(es) for accessing or downloading multimedia resources, e-commerce or m-commerce sites, etc.). It will be understood that many different types of data may be provided.

The system has a number of similarities with the existing domain name server (DNS) system. A DNS will receive a request containing an alphanumeric address and will return the IP address associated with that alphanumeric address to a client application so that a communication session may be initiated, using, for example, the ftp or http protocols. In the present invention, a database query will be run in response to a request from a client application (this is similar to a DNS look-up) and an address is returned to the client application which can be used to access the desired data. This similarity enables DNS infrastructure to be used in the implementation of the present invention.

FIG. 2a shows an example of a data record 22 associated with a registered user. In this case, the data record 22 comprises a single text record 23, for example relating to the geographical location of the registered user, and a set of data 24, for example contact data or content data. FIG. 2b shows an alternative data record 22a comprising a single text record 23a and a plurality of data sets 24a, 24b & 24c with hierarchy data 25 relating the plurality of data sets to the text record. The plurality of data sets may relate to contact details for different family members or to the different departments or aspects of a business or large organisation.

In use, a user will send a query to the system regarding a registered user. To simplify the request process, the system is operated as a top level domain (TLD) such that a user may be identified by an identifier such as johnsmith.tel or smithfamily.tel. If the data record associated with the identifier is a single data record (as shown in FIG. 2a) then the text record and the data set will be returned to the user. The user may then use the data held within the data set to initiate a communication session. For example, if the data set comprises contact details then selecting a telephone number will cause the selected number to be dialled or a new email message will be initiated if an email message is selected, etc. If the data set comprises content details then selecting an internet address will cause the associated data to be downloaded or streamed to the mobile communications device of the user.

The operation of the system 100 to implement the functionality described above will now be described in detail with reference to FIG. 1 and FIGS. 3 & 4. In order to become a registered user of the system it is necessary for a user to provide a set of registration data to the registrar 30, the registration data comprising an identifier for a registered user and the associated text record and data set(s). The registrar will then query the registry 40 to determine whether or not the requested registered user identifier is available.

The registrar will then query the NSP 60 to determine whether the registration data is in the correct format, and, if the registration data comprises multiple data sets, the registrar will query the NNSP 70 to determine whether the registration data is in the correct format. If the registration data is in the correct format then the registered user identifier is written to the registry; this is confirmed by the registry to the registrar and the registrar reports the registration of the user identifier to the user. If the registration data comprises a single data set then this data set is sent to the NSP 60 and is stored in the NSP database 80 such that the data can be accessed. Alternatively, if the registration data comprises multiple data sets then the multiple data sets will be sent to the NSP 60 and stored in the NSP database 80 such that the data can be accessed. Furthermore, the hierarchy data 25 is sent to the NNSP 70 and is stored in the NNSP database 90.

In the event that the registration data is not correct, the data will be returned to the user and an error reported. The registered user identifier may also be written to the search engine 50 so that users are able to search for the registered user. The user may also be prompted to provide one or more keywords that can be indexed within the search engine to facilitate the identification of the user or the business in which a user is active.

In use, a user will send a request to the registry. The user 10 comprises a mobile communications device 11 (referring to FIG. 3) which comprises both hardware and software components. The mobile communications device comprises a processor 12, non-volatile storage means 13, RAM 14, operating system 15, browser application and a client application 17 according to an embodiment of the present invention. The device further comprises a display screen 18 that indicates to a user the actions being undertaken by the device and displays data received from a communications device. It will be readily understood that the specific nature of the device 11 is not critical to the present invention. The device may be a mobile telephone, a ‘smartphone’ or a communications enabled PDA. The operating system may be the Symbian OS, Microsoft Smartphone or Windows CE, etc. The browser application may be Microsoft Pocket Internet Explorer, Openwave Browser 2, etc. The device 11 may use any network access technology, for example WAP over GSM, GPRS, 3G networks, Wi-Fi, etc. in order to access a system according to the present invention.

The client application can be used to send either a ‘look-up’ request or a ‘search’ request to the registry 40. For a ‘look-up’ request the client application performs a DNS look-up on the registry, with the subject of the request being a registered user identifier. The registry returns the address of the NSP associated with the registered user identifier to the mobile communications device. In response to this, the mobile communications device will perform a further DNS look-up with the identified NSP. The NSP will locate the text record and data sets associated with the registered user identifier in the NSP database and return the data to the mobile communications device. The mobile communications device will then present the data to the user. If the data set comprises contact data then the user will be presented with a number of icons or hyperlinks associated with each potential communication channel. The user's selection of one of these options will initiate communication using the selected communication channel. If the data set comprises content data then the user will be presented with a number of icons or hyperlinks associated with the different types and/or sources of content. The user's selection of one of these options will initiate access to the content.

If the requested registered user identifier comprises more than one data set then the process described above is altered. As before, the ‘look-up’ request comprises the client application performing a DNS look-up on the registry with a registered user identifier as the subject of the request. The registry returns the address of the NSP associated with the registered user identifier to the mobile communications device. In response to this, the mobile communications device will perform a further DNS look-up with the identified NSP. The data returned to the mobile communications device by the NSP is the text record and the address of the NNSP associated with the requested registered user identifier. The mobile communications device will then perform a DNS look-up on the identified NNSP, which locates the requested hierarchy data 25 in an NNSP database and returns it to the mobile communications device. The user then examines the hierarchy data and selects a desired option. The NNSP database may then return the address of the NSP database associated with the data set that is associated with the selected option, enabling the mobile communications device to perform a DNS look-up on the identified NSP. The NSP will locate the required data set in an NSP database and return the data set to the mobile communications device so that it can be presented to the user. The user may then initiate communication or access content as described above.

Alternatively, the NNSP database may then return a user identifier to the mobile communications device, the user identifier being associated with the selected option and also reflecting the hierarchical relationship between the chosen option and the user identifier that was originally requested. The mobile communications device can assume that this user identifier is only associated with a single data set and thus the process described above with respect to a single data set may be performed to access the content or contact data held within the data set.

If the mobile communications device performs a ‘search’ request then one or more search integers will be sent to the search engine 50. Each search integer may comprise a registered user identifier or one or more keywords. The search engine will search the registry 40 and the NSP database to provide one or more matches against the search request integers. The search matches may be made against other registered user identifiers that are spelt similarly to the search request integers or against other entries having a match for one or more keywords. The most relevant matches are returned to the user so that the user can navigate through the returned results and by selecting one of the matches the text record can be displayed. Additionally, if the result is associated with a single data set this may be displayed or the hierarchy data may be displayed if the result is associated with multiple data sets. The user may then make contact with the registered user (or access content data) as described above. In the event that a user makes a look-up request that is unsuccessful, i.e. the NSP does not return any results to the client application, the client application may send a search request using the requested registered user identifier from the look-up request without requiring any input from the user.

FIG. 4 shows a further embodiment of a system according to the present invention. As has been discussed above, the system has some similarities with the DNS system presently used and thus there may also be a plurality of registrars, registries, search engines, name service providers, name navigation service providers, NSP databases and NNSP databases. The plurality of these features may be provided by one or more organisations or entities operating as registrars, NSPs, NNSPs, etc., or through the provision of multiple instances of databases, for example caching of databases, or the use of distributed databases. Furthermore, as with the DNS system, there may be one or more root servers or databases, with further servers or databases being used for sub-domains.

The domain that applies to the system of FIGS. 1 & 4 may be have further divisions to enable greater use of the domain by enabling re-use of elements of registered user identifiers, for example johnsmith.us.tel, johnsmith.au.tel, smithfamily.us.tel, etc. It will be readily appreciated that although the foregoing discussion is limited to the use of content or contact datasets being associated with a user identifier, other types or categories of data can be used without changing the nature of the invention.

Furthermore, although the invention is primarily intended for access by mobile communications devices, such as mobile telephones and network enabled PDAs, it will be understood that fixed-network devices, such as PCs, smart phones, internet phones, etc. may also access a system according to the present invention.

In use a system according to the present invention will be implemented in software, and such software may be provided on a data carrier, such as a floppy disk, CD, DVD, etc. or may be offered for download or transmission over a communications network.

1. A communications system comprising a first database and a second database, the first database comprising data identifying a system user and the second database comprising one or more data sets relating to a system user, wherein
i) the first database additionally comprises data indicating the location of the one or more data sets relating to that user;
ii) the second database comprises a plurality of data sets relating to a system user; the system being characterised in that:
iii) the system further comprises a third database, the third database comprising hierarchical data defining a relationship between the plurality of data sets.

2. A communications system according to claim 1, the system further comprising a search engine, the search engine, in use, accessing data stored in the first database and/or the second database.

3. A communications system according to claim 1, wherein the system includes a plurality of one or more of the following group: the first database, the second database, the third database or the search engine.

4. A communications system according to claim 1 wherein the first database, on receiving a first request from a client terminal sends a first response to the client terminal, the first request comprising identification data for a system user and the first response comprising data indicating the location of one or more data sets relating to that user.

5. A communications system according to claim 4, wherein the second database, on receiving a second request from a client terminal sends a second response to the client terminal, the second request comprising an identification of a requested data set and the second response comprising the requested data set.

6. A mobile communications device comprising processor means, data storage means, memory means and display means, the device, in use being configured to:
i) send a first request comprising a user identifier to a first system database;
ii) receive a first response from the first system database comprising a location for a second system database;
iii) send a second request to the location of the second system database;
iv) receive a second response from the second system database comprising a data set related to the user identifier comprised in the first request;
characterised in that the device is configured to
v) send a third request to a third system database; and
vi) receive a third response from the a third system database comprising hierarchical data defining relationships for the data set received in step iv) between the of second data records.

7. A communications system comprising a first database and a second database, wherein:
the first database comprises a plurality of first data records, each of the first data records being associated with a registered user of the communications system and comprising a registered user identifier and a data resource locator; and
the second database comprises a plurality of second data records, each of the second data records being associated with a registered user of the communications system and comprising one or more data sets associated with that registered user,
the system being configured such that when a first data record is added to the first database, the system adds a second data record to the second database, the contents of the second data record being derived from the data submitted to the first database;
the system being characterised in that the system further comprises a third database, the third database comprising a plurality of third data records, each third data record being associated with a registered user further associated with a first data record and a plurality of second data records, wherein each third data record comprises hierarchical data defining a relationship between the plurality of second data records.

8. A communications system according to claim 7, wherein the data resource locator of the first data record associated with a registered user indicates the location of the second data record associated with that registered user.

9. A communications system according to claim 7, wherein the system further comprises a search engine, the search engine configured to search the first and/or the second database.

9. A communications system according to claim 7, wherein the system further comprises a search engine, the search engine configured to search the first and/or the second database.

10. A communications system according to claim 8, wherein the system further comprises a search engine, the search engine configured to search the first and/or the second database.
